(19) United States
(12) Patent Application Publication
(10) Pub. No.: US 2017/0347543 A1
(43) Pub. Date: Dec. 7, 2017

(54) Apparatus and Methods for Wireless Transmission of Alarm Condition Information from Zones in an Irrigation System

(71) Applicant: Rainboxx, Inc., Austin, TX (US)

(72) Inventor: Alex Khabbaz, Austin, TX (US)

(73) Assignee: Rainboxx, Inc., Austin, TX (US)

(21) Appl. No.: 15/170,651

(22) Filed: Jun. 1, 2016

(51) Int. Cl. A01G 25/16

(52) U.S. Cl. CPC A01G 25/165

(57) ABSTRACT

A method of wirelessly transmitting alarm condition information is applicable to an irrigation zone including a zone input conduit connected to a main distribution conduit of the irrigation system. The zone further includes a zone distribution conduit, a zone valve connected between the zone input conduit and the zone distribution conduit, and at least one irrigation emitter connected in the zone distribution conduit. The method includes detecting an alarm condition at the irrigation zone, and at a designated time proximate to one of a start time and an end time for to an irrigation session for the irrigation zone, controlling the zone valve according to a zone valve control sequence corresponding to the detected alarm condition. The zone valve control sequence comprises a predefined pattern of open and closed states of the zone valve over time.

### TECHNICAL FIELD OF THE INVENTION

The present invention relates to irrigation systems in which various irrigation zones are controlled wirelessly. More particularly, the invention includes methods and apparatus for facilitating wireless transmissions of alarm condition information from various irrigation zones in an irrigation system to an irrigation system control unit.

### BACKGROUND OF THE INVENTION

Modern irrigation systems, particularly those used in residential settings, commonly include a network of distribution conduits including a number of separately controlled irrigation zones. The network of distribution conduits is connected to a supply conduit that supplies irrigation under suitable pressure, and a master valve is used to control the water supply from the supply conduit. Each irrigation zone includes a zone valve which is opened for an irrigation session in the respective zone, and then closed while another irrigation zone is operating. An irrigation controller is typically included in the irrigation system to open and close both the master valve and zone valves as needed according to an irrigation schedule. In particular, the irrigation controller controls the master valve to open simultaneously with a first zone valve in the irrigation system. Once the irrigation session for the zone controlled by the first valve is complete, the controller closes the first valve and opens a second zone valve for an irrigation session for that zone. The irrigation controller continues to operate the zone valves sequentially for the given irrigation schedule, and then closes both the final zone valve in the sequence and the master valve at the end of the program.

In order to control the master valve and zone valves, the irrigation controller must be able to send to the respective valve a signal which either operates the valve or triggers another signal to operate the valve. Perhaps the most common arrangement currently used for residential irrigation systems is an arrangement in which the irrigation controller sends operating signals to the master valve and each zone valve through a respective electrical wire which runs from a terminal of the irrigation controller to the respective valve. The operating signals are at a suitable voltage to operate the respective zone or master valve, which is commonly a solenoid-operated valve.

The electrical wires which run to the various remote valves in this common arrangement represent a weak link in the system for a number of reasons. First there is the added cost of the electrical wires and the cost of installing the wires. Additionally, the wires are subject to damage during yard work. The wires and connections to the wires are also subject to corrosion since they are exposed to a relatively harsh outdoor and underground environment.

In order to address some of the problems with having to run electrical wires in an irrigation system, irrigation systems have been proposed which eliminate the need for such wires. In particular, U.S. Pat. No. 7,383,721 discloses an irrigation system in which the remote zone valves are controlled through communications encoded in pressure pulses applied to the irrigation water in the network of irrigation conduits. The pressure pulses in this proposed system are detected and interpreted by a signal receiving arrangement associated with the remote zone valve, and the receiving arrangement then produces a suitable operating signal to open or close the valve accordingly. U.S. Pat. No. 7,383,721 also discloses an arrangement by which the remote zone valves communicate information back to a central control system. This communication is accomplished by opening and closing the zone valve in predefined patterns to produce pressure variations which can be sensed and interpreted at the central control system. The communications from each zone to the central control system are performed at scheduled times separate from irrigation times to ensure that the zone valves can be opened and closed to produce the desired pressure variations in the system. However, this arrangement for communications from the zones to the central control system constrained irrigation times and required complex time synchronization between the central control system and the various zones. Furthermore, the system did not facilitate the transmission of alarm condition information from the zones to the central control system.

### SUMMARY OF THE INVENTION

The present invention provides an irrigation zone control device that facilitates the wireless transmission of alarm condition information to a system control unit without elaborate time synchronization between the various units in the system and without introducing significant constraints on irrigation times in the system. The invention also encompasses an irrigation system incorporating such zone control devices, and also methods of wirelessly transmitting alarm condition information from an irrigation zone of an irrigation system.

According to one aspect of the invention, a method of wirelessly transmitting alarm condition information is applicable to an irrigation zone including a zone input conduit connected to a main distribution conduit of an irrigation system. The zone further includes a zone distribution conduit, a zone valve connected between the zone input conduit and the zone distribution conduit, and at least one irrigation emitter connected in the zone distribution conduit. The zone valve is operable to reside alternately in an open state enabling fluid flow from the zone input conduit to the zone distribution conduit and a closed state blocking fluid flow from the zone input to the zone distribution conduit. The method according to this aspect of the invention includes detecting an alarm condition at the irrigation zone, and at a designated time proximate to one of a start time and an end time for to an irrigation session for the irrigation zone, controlling the zone valve according to a zone valve control sequence corresponding to the detected alarm condition. The zone valve control sequence comprises a predefined pattern of open and closed states of the zone valve over time.

Because the zone valve control sequence includes a pattern of open and closed states of the zone valve, and because opening the zone valve has the effect of allowing irrigation water to flow out through the zone distribution conduit and the various emitters in that conduit, the zone valve control sequence produces a pattern of pressure and flow rate variations in the main distribution conduit which can be recognized by an appropriate sensor located remotely from the zone. Furthermore, because the zone valve control sequence is performed at designated times proximate to the start or end time of an irrigation session for the irrigation zone, the transmissions of information from the irrigation zones require no elaborate timing and synchronization with a receiving device, and do not constrain irrigation times. Additionally, since the designated times are proximate to the start or end time of an irrigation session, times when the system master valve is already open, the present invention avoids having to open a system master valve at off irrigation times to facilitate transmissions from the various zones.

Another aspect of the present invention encompasses a zone control device for an irrigation zone as described above. A zone control device according to this aspect of the invention includes a zone valve output terminal and a zone valve signal circuit. The zone valve signal circuit is operable to apply a zone valve drive signal to the zone valve output terminal in response to a zone valve control signal. The zone control device further includes a zone unit controller and a battery connected to supply operating power to the zone control device. The zone controller unit, which may comprise a suitable microcontroller, has an alarm condition input and is operable to, in response to an alarm condition signal received at the alarm condition input, direct the zone valve control signal to the zone valve signal circuit according to the zone valve control sequence. In particular, the zone valve control signal is directed to the zone valve circuit at a designated time proximate to the start or end time of an irrigation session for the irrigation zone. As noted above, the zone valve control sequence comprises a predefined pattern of open and closed states of the zone valve over time so that the sequence produces a pattern of pressure and flow variations in the main distribution conduit that can be sensed by a suitable sensor connected to the main distribution conduit.

A further aspect of the invention encompasses an irrigation system including a main distribution conduit and a number of irrigation zones as described above for the previously described aspects of the invention. At least one of the irrigation zones in this system includes a zone control device as described above.

In the above description of an irrigation system to which the present methods apply, various elements are described as being “connected” to another element or between elements. For example, the preceding paragraph describes the zone valve as being “connected” between the zone input conduit and the zone distribution conduit. The term “connected” in this example and elsewhere in this disclosure and the accompanying claims means “operatively connected” so that the device may perform its stated function. Thus the zone valve described above and elsewhere in this disclosure and the following claims is connected to the zone input conduit and to the zone distribution conduit so that the valve blocks flow from the zone input to the zone distribution conduit when the valve is in the closed state, and (under a suitable supply pressure in the main distribution conduit) allows flow from the zone input conduit to the zone distribution conduit when the valve is in the open state. As a further example, the above description that the battery is “connected” to supply operating power to the zone control device means that the terminals of the battery are connected via suitable electrical conductors (directly or through various circuit elements) ultimately to various elements of the zone control device requiring electrical power input for operation.

According to the various aspects of the invention, the zone valve is controlled according to the zone valve control sequence at a designated time “proximate” to either the start time or end time for an irrigation session for the irrigation zone. As will be described more fully below, it is the proximity of the zone valve control sequence to an irrigation session start and/or end time that allows the transmission of alarm condition information from the irrigation zones without requiring a timing scheme separate from the irrigation schedule itself. As used in this disclosure and the following claims, the term “proximate” is used to mean sufficiently close in time to the start or end time of a given irrigation session so that the pressure and/or flow pattern resulting from a zone control sequence for one zone does not overlap with the pressure and/or flow pattern resulting from a zone control sequence for another zone in an irrigation schedule for the zones. Typically, a zone valve for a given zone will be controlled according to the zone control sequence any time up to five (5) minutes before a session start time for a zone or five (5) minutes after a session end time for a zone, or at any time within the time period for the given session. Preferably, the zone valve for a given zone is controlled according to the zone valve control sequence immediately (within seconds) before a session start time, immediately after the session start time, immediately before the session end time, or immediately after the session end time.

In any of the aspects of the invention the designated time may be determined relative to the start time for the irrigation session and the zone valve control sequence ends with the zone valve in the open state. Alternatively or additionally, the designated time may be determined relative to an end time for the irrigation session and the zone valve control sequence ends with the zone valve in the closed state.

In some embodiments according to any of the aspects of the invention, the alarm condition to be detected is an alarm condition relating to the battery which powers the zone control device. Thus detecting the alarm condition may include reading a battery status signal comprising a signal indicative of the state of charge or state of health for the battery providing power for the zone control device. Also, the alarm condition detection may be performed at a detection time defined relative to the time of the irrigation session. Although preferred implementations may be adapted to control the zone valve in accordance with the zone valve control sequence (indicating a battery condition) at the designated time proximate to the end or start of an irrigation session at the zone, it is possible to control the zone valve in accordance with the zone valve control sequence at other times to indicate a battery condition.

Methods according to the present invention may include steps to detect the pressure and/or flow variations resulting from the control of a zone valve according to a zone valve control sequence. Detecting such a pattern of pressure and/or flow variations represents receiving the information represented by the pattern, namely the presence of the alarm condition which prompted the control according to the zone valve control sequence. The steps taken at a remote location (and particularly the location of a master/pulser unit for a pressure pulse-based control system) may include, at the designated time, sensing a zone state-indicating parameter of the main distribution conduit (a parameter such as pressure or flow rate) at the remote location. In response to detecting a pattern of the zone state-indicating parameter resulting from the application of the zone control sequence, the detecting device or a related device may perform a corresponding action such as sending an alarm message relating to the alarm condition which prompted the application of the zone control sequence. Thus a system user or operator may be made aware of the alarm condition at the subject irrigation zone, such as a low battery condition.

These and other advantages and features of the invention will be apparent from the following description of representative embodiments, considered along with the accompanying drawings.

### BRIEF DESCRIPTION OF THE DRAWINGS

FIG. 1 is a block diagram showing an irrigation system incorporating zone units each having a zone control device according to one aspect of the present invention.

FIG. 2 is a block diagram of the master/pulser unit shown in FIG. 1.

FIG. 3 is a block diagram of the master/pulser control device shown in FIG. 2.

FIG. 4 is a block diagram of a zone unit according to one aspect of the present invention.

FIG. 5 is a block diagram of the zone control device shown in FIG. 4.

FIG. 6 is a flow chart showing a method performed at the zone control device of FIG. 5.

FIG. 7 is a flow chart showing a method performed at the master/pulser control device of FIG. 3.

### DESCRIPTION OF REPRESENTATIVE EMBODIMENTS

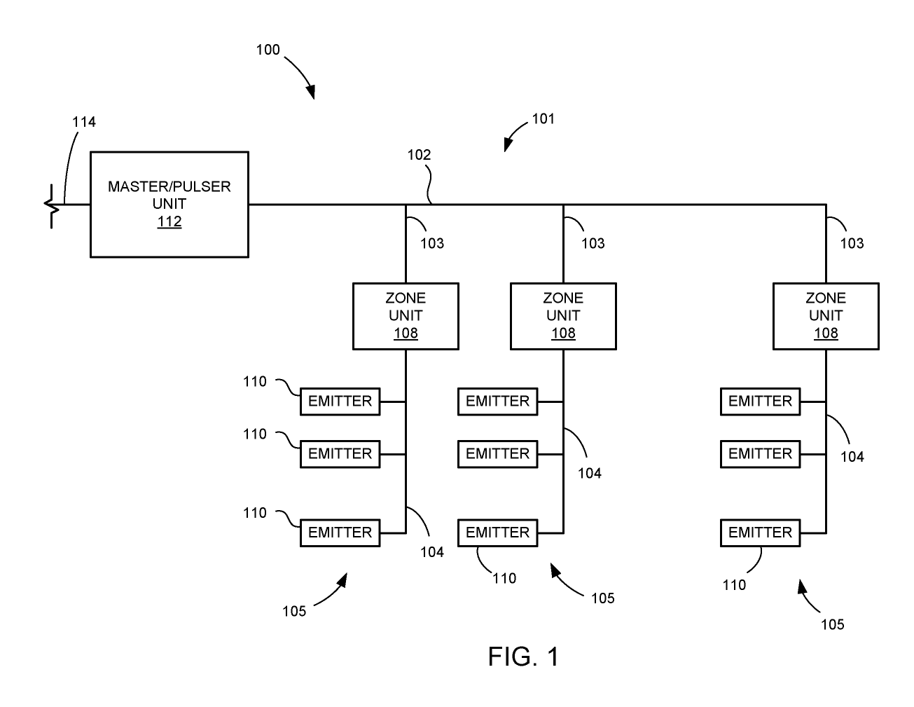

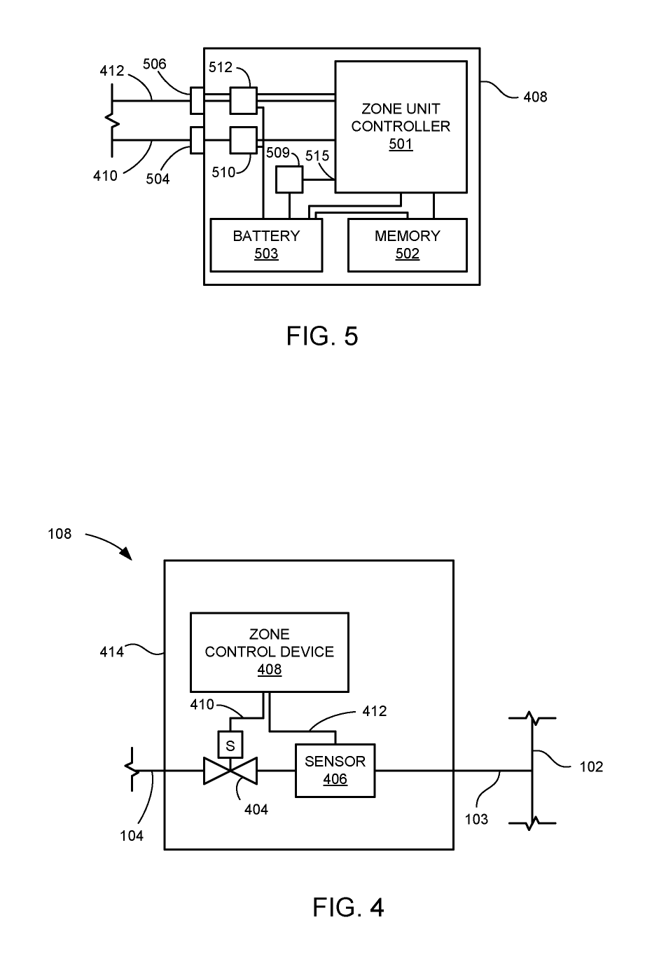

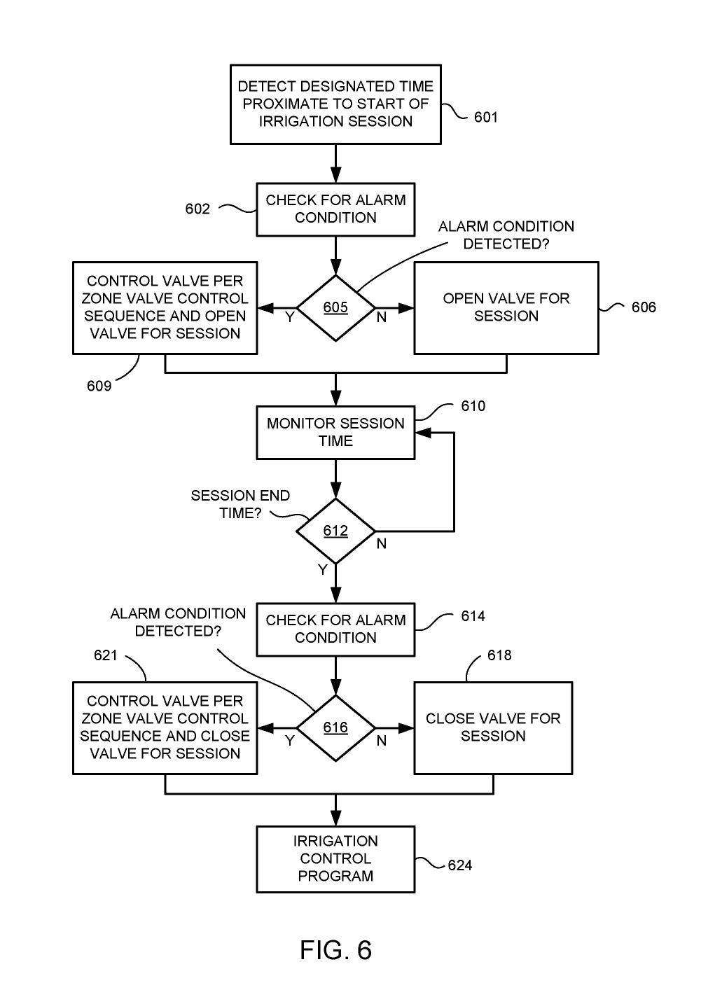

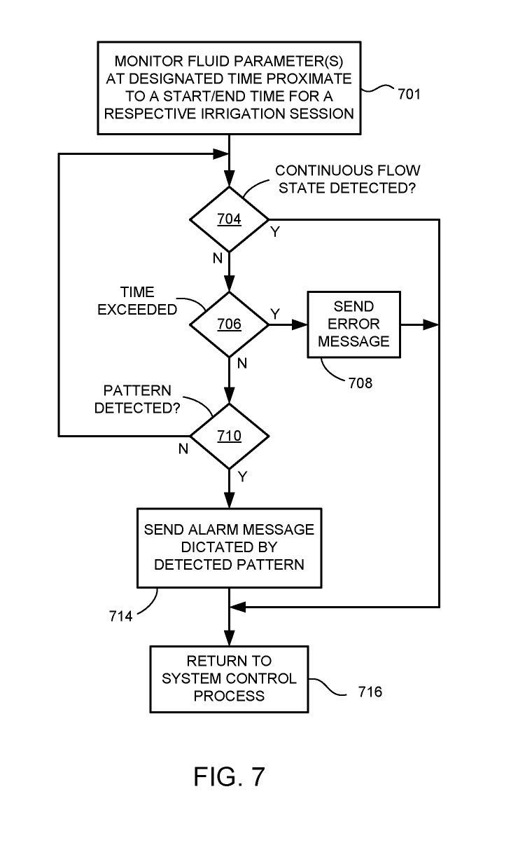

In the following, FIGS. 1-5 will be used to describe an irrigation system in which the present invention may be implemented. In particular, a zone control device according to an aspect of the invention will be described in connection with FIGS. 4 and 5. FIG. 6 will be referenced below to describe the operation of the zone control device and methods encompassed by the present invention. The flow diagram of FIG. 7 will be used to describe remote detection of the pattern of pressure and/or flow rate resulting from the operation of the zone control device.

Referring to FIG. 1, an irrigation system 100 in which the present invention may be employed includes a network 101 of irrigation conduits including a main distribution conduit 102. A zone input conduit 103 and zone distribution conduit 104 are included for each of a number of irrigation zones shown generally a reference numeral 105. A zone unit 108 is connected between the zone input conduit 103 and zone distribution conduit 104 for a respective irrigation zone. As will be discussed below in connection with FIG. 4, each zone unit 108 includes a set of components which cooperate to control the flow of irrigation water to emitters 110 which are connected to the respective zone distribution conduit 104 for the zone. Emitters 110 may include any suitable spray nozzle, bubbler or drip emitter, dripper line, or any other irrigation water emitter suitable for a given situation. Regardless of the particular type of emitters 110, the emitters associated with a given zone distribution conduit 104 are typically spaced apart appropriately and selected to apply a desired amount of irrigation water to the respective zone 105 of the irrigation system over a time period of an irrigation session in which the zone is activated. Although FIG. 1 shows three irrigation zones 105, the present invention may, of course, be used with irrigation networks comprising any number of irrigation zones. A network of irrigation conduits may include more or fewer than three irrigation zones 105, however, generally there will be at least two different zones in an irrigation system to control the irrigation of two different areas. Similarly, although the example of FIG. 1 shows three emitters 110 associated with each irrigation zone 105, more or fewer emitters may be included in a given zone 105, and the various irrigation zones may include different numbers of emitters 110. Also, an irrigation system in which the invention may be employed is not limited to any particular application or setting. For example, irrigation system 100 may control irrigation for a residential landscape or garden, a commercial landscape or garden, or even conceivably a commercial farm.

In addition to controlling irrigation to the respective zone 105, each zone unit 108 may be operable according to aspects of the present invention to wirelessly transmit an indication of an alarm condition at the zone unit. This information is represented by variations in a parameter such as pressure or flow rate of irrigation fluid in the irrigation system 100 as will be described below particularly with reference to FIG. 6.

FIG. 1 also shows that irrigation system 100 includes a master/pulser unit 112. Master/pulser unit 112 cooperates with the various zone units 108 to control the flow of irrigation water in the system. In particular, master/pulser unit 112 functions generally to selectively allow the flow of irrigation water into the network 101 of irrigation conduits from a supply conduit 114, and also communicates with zone units 108 through encoded pressure pulses introduced into the irrigation water within the network of irrigation conduits. According to aspects of the present invention, master/pulser unit 112 may also receive the wireless transmissions from zone units 108, and may be configured to perform certain actions in response to those transmissions.

It should be noted here that although the present invention is directed to apparatus and methods used with pressure pulse-based communications to control various irrigations zones in an irrigation system, the various aspects of the present invention are independent of the communications from the master/pulser unit 112 to the various zone units 108. Thus, details of the pressure pulse generation and encoding performed by master/pulser unit 112, and detection and interpretation at the various zone units are not necessary for an understanding of the present invention. Such details are therefore omitted from this disclosure so as not to obscure the invention in unnecessary detail.

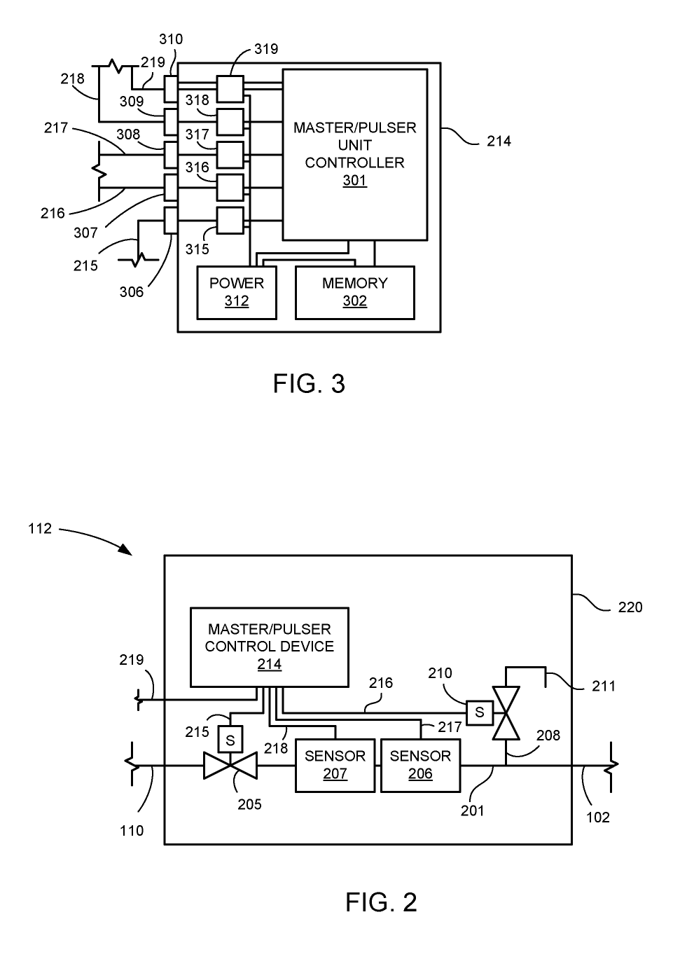

Referring to FIG. 2, master/pulser unit 112 defines a flow path 201 (which may simply be a length of suitable conduit) between supply conduit 114 at one end and main distribution conduit 102 at the opposite end. A supply control valve 205 is connected in the conduit defining flow path 201 as is a pressure sensor device 206 and a flow sensor device 207. A branch conduit 208 is connected to flow path 201 and includes a pulser valve 210 operative to selectively open the branch conduit to atmosphere through the open distal end 211. The two valves 205 and 210 are preferably electrically operated valves such as suitable solenoid controlled valves, and are each connected by a suitable electrical line to a master/pulser control device 214 which controls the operation of the valves. Master/pulser control device 214 is also connected to receive signals from pressure sensor 206 and flow sensor 207. The example of FIG. 2 shows electrical control line 215 to supply control valve 205, electrical control line 216 to pulser valve 210, electrical line 217 to pressure sensor 206, and electrical line 218 to flow sensor 207. These electrical lines may simply comprise suitable light gauge wires for carrying the signals described further below. Master/pulser control device 214 is also shown as being connected to an external communications line 219, which may comprise a serial communications cable, or any other transmission path for transmitting instructions or other data to and/or from the master/pulser control device. Typically the various components of master/pulser unit 112 may be stored in a suitable housing such as a suitable irrigation valve box 220.

FIG. 3 shows a schematically represented example of master/pulser control device 214 included in the master/pulser unit 112 illustrated in FIG. 2. This example control device 214 includes a master/pulser unit controller 301 (which may be a suitable microcontroller) with external memory 302. Master/pulser control device 214 also includes an input/output arrangement including a supply output terminal 306, a pulse generation output terminal 307, a pressure sensor input terminal 308, a flow sensor input terminal 309, and an input/output port 310. Referring to both FIGS. 2 and 3, pulse generation output terminal 307 may be connected to electrical control line 216 extending from the control unit to pulser valve 210 while supply output terminal 306 may be connected to electrical control line 215 extending to supply valve 205. Pressure sensor input terminal 308 may be connected to the electrical control line 217 extending to pressure sensor 206, and flow sensor input terminal 309 may be connected to electrical control line 218 extending to flow sensor 207. Input/output port 310 may be connected to the external input/output line 219. Power for the input/output arrangement, controller 301, and external memory 302 is provided through a suitable power supply 312 included in control device 214. Power supply 312 may include a suitable battery for example. Power for operating the various components of control device 214 may also come from an external source even though no external power connection is shown in FIG. 3. Even where external power is used, a battery may still be included to provide backup power should the external source fail.

In the illustrated example master/pulser control device 214 shown in FIG. 3, each input or output terminal is connected to a suitable driver circuit that provides an interface to master/pulser unit controller 301. Pulse generation output terminal 307 is connected to a communication signal circuit 316, while supply output terminal 306 is connected to a supply signal circuit 315. These driver circuits for the output terminals may be any suitable circuit for receiving a control signal from controller 301 and, in response to the control signal, applying a suitable signal to the respective terminal to control the connected valve. For example these driver circuits may include a suitable transistor which applies a signal at a suitable voltage to the respective output terminal in response to a control signal from controller 301. Each input terminal is also shown connected to a suitable driver circuit, with pressure sensor input terminal 308 connected to a pressure sensor driver circuit 317 and flow sensor input terminal 309 connected to a flow sensor driver circuit 318. These driver circuits for the input terminals may be a suitable circuit adapted to receive an analog or digital input signal from the respective input terminal and, in response to that received signal, apply a suitable digital signal to one or more pins of microcontroller 301. Input/output port 310 is connected to an external input/output driver circuit 319 which cooperates with controller 301 to both transmit data from port 310 and receive data at that port. The data transmission and reception may be pursuant to any suitable standard or technique. For example, port 310 may be configured as an RS-232 port or a USB port, and the circuit 319 may be configured accordingly.

Master/pulser unit controller 301 may comprise any controller suitable for performing the process described more fully below with reference to FIG. 7. In a typical installation, controller 301 will also be responsible for executing an irrigation program in which the different irrigation zones are activated according to some schedule. Also, since the irrigation system 100 relies on pressure pulse-based communications to control the various zone units 108, controller 301 will be programmed to direct pulser valve 210 to generate pressure pulses encoded according to a suitable encoding scheme. As noted above, the specifics of this pressure pulse communication from master/pulser unit 112 to the zone units 108, including the encoding scheme, are not necessary for an understanding of the present invention and are thus omitted here. Similarly, the details of any irrigation program executed by controller 301 are also unnecessary for an understanding of the present invention and such details are also omitted.

FIG. 4 shows an example zone unit 108 which may be employed in the irrigation system shown in FIG. 1. The schematic diagram of FIG. 4 shows that zone unit 108 includes a zone valve 404 and a pressure sensor 406. Zone valve 404 is connected between zone distribution conduit 104 for the given zone and zone input conduit 103 (the latter extending from main distribution conduit 102). Pressure sensor 406 is connected in this example zone unit 105 in the zone input conduit 103. Zone valve 404 is preferably an electrically operated valve such as suitable solenoid controlled valve (preferably a latching solenoid controlled valve), and is connected by a suitable electrical line 410 to a zone control device 408 which controls the operation of the valve. Zone control device 408 is also connected to receive signals from pressure sensor 406 via a suitable electrical line 412. Similar to the electrical lines 215, 216, 217, and 218 shown in FIG. 2, electrical lines 410 and 412 may simply comprise suitable light gauge wires for carrying the electrical signals described further below. As in the case of the master/pulser unit 112 shown in FIG. 2, the various components of zone unit 105 may be stored in a suitable housing such as a suitable irrigation valve box 414. Also, although zone unit 108 is described here as having zone valve 404 connected directly to zone input conduit 103 and zone distribution conduit 104, it will be appreciated that each zone unit may have a separate conduit in which the zone valve 404 and pressure sensor 406 may be connected. Thus the connection between zone valve and conduits 103 and 104 may be indirect. This separate conduit arrangement facilitates packaging the zone unit as unified product which may be connected in an irrigation system as indicated in FIG. 1.

FIG. 5 shows a schematically represented example of zone control device 408 included in the zone unit 108 illustrated in FIG. 4. This example zone control device 408 includes a zone unit controller 501, external memory 502, and a battery 503. Zone control device 408 also includes an input/output arrangement including a zone valve output terminal 504 and a sensor input terminal 506. Referring to both FIGS. 4 and 5, zone valve output terminal 504 is connected to electrical line 410 extending from the zone control device to zone valve 404, while sensor input terminal 506 is connected to electrical line 412 extending to pressure sensor 406. Although not shown in FIG. 5, implementations of zone control device 408 may include a device for recharging battery 503. Such a recharging device may be driven by energy of the irrigation water which flows through the zone conduits (103 and 104 in FIG. 1) when the zone unit 108 is active for an irrigation session. For example, a turbine may be connected in one of the zone conduits and operate to turn a generator when during an irrigation session at that zone. Alternatively, the recharging device may be solar powered (a photovoltaic device) or powered in any other suitable fashion.

In the illustrated example zone control device 408 shown in FIG. 5, the input and output terminals, 504 and 506, respectively, are each connected to a suitable driver circuit that provides an interface to controller 501. Zone valve output terminal 504 is connected to a zone valve signal circuit 510, while sensor input terminal 506 is connected to a sensor signal circuit 512. The driver circuit 510 may be any suitable circuit for receiving a control signal from controller 501 and, in response to the control signal, applying a suitable signal to the corresponding terminal 504 to control the connected valve. As in the example driver circuits described above in connection with FIG. 3, this driver circuit may include a suitable transistor which applies a signal at a suitable voltage to the respective terminal in response to a control signal from microcontroller 501. Input terminal driver circuit 512 (similar to circuits 317 and 318 in FIG. 3) may be a suitable circuit adapted to receive an analog or digital input signal from the respective input terminal and, in response to that received signal, apply a suitable digital signal to one or more pins of microcontroller 501. Those skilled in the art will recognize that driver circuits separate from microcontroller 501 may not be needed in some implementations, especially for the input from pressure sensor 406 (and sensors 206 and 207) in FIG. 2. Rather, the sensor in the given case may be adapted to output a sensor signal that may be applied directly to a digital or analog input pin of the microcontroller. In these cases the driver circuit is essentially incorporated in the controller 501. Similarly an output circuit for applying the appropriate signal at terminal 504 may be incorporated in controller 501.

Controller 501 may comprise any controller or microcontroller suitable for performing the process described more fully below with reference to FIG. 6. In a typical installation, controller 501 will also be responsible for executing an irrigation zone program in which the zone activated for irrigation according to some schedule communicated to the zone unit from master/pulser unit 112 or according to control signals communicated from the master/pulser unit. Also, since irrigation system 100 relies on pressure pulse-based communications to control the various zone units 108, controller 501 will be programmed to process signals from pressure sensor 406 representing communications from master/pulser unit 112. Because the nature of the communications from master/pulser unit 112 to the zone units 108, including the encoding scheme, are not necessary for an understanding of the present invention, details on those communications are omitted here. Similarly, the details of any irrigation program executed by controller 501 are also unnecessary for an understanding of the present invention and such details are also omitted. Regardless of the details of the irrigation program executed by controller 501, it will be appreciated that the controller ultimately identifies an irrigation session start time, or is communicated an irrigation start command at a given time, and then operates to open the zone valve for that irrigation session. As will be described below in connection with FIG. 6, the present invention facilitates the transmission of alarm condition information for the particular zone unit 108 in connection with a start and/or end time for an irrigation session.

Power for the input/output arrangement (including the operating signal for zone valve 404), controller 501, and external memory 502 is provided through battery 503, which may comprise any suitable type of battery. Because zone units 108 in a pressure pulse-based system such as that shown in FIG. 1 do not have any other way to power the zone valve 404 to implement the desired irrigation program, the state of battery 503 is critical to the operation of the system. In particular, if the battery power is too low to operate the zone valve at the start of an irrigation session, the zone will not operate for the desired session and thus leave the area for the zone unirrigated. Worse, if the battery power is insufficient to close the valve at the end of an irrigation session, the zone may continue to apply and waste irrigation water. This continuation of irrigation outside of the desired session time may also interfere with irrigation in the other zones by interfering with the water pressure required for proper operation of an irrigation zone. Thus the wireless transmission arrangement of the present invention is particularly suited for providing a transmission from the zone unit 108 to a remote receiving device (which may be incorporated in the master/pulser unit 112) to indicate that the battery is approaching a low power limit. The remote receiving device may then provide an appropriate signal to a user to change the zone unit battery before it fails.

In view of this useful application of wireless data transmission according to the present invention, the example zone control device 408 shown in FIG. 5 includes a battery output monitoring circuit 509 connected to battery 503 and operable to provide a suitable signal to an alarm condition input 515 of zone unit controller 501 when the battery state of charge and/or state of health falls to a predefined level prior to a failure level. This monitoring circuit may be any suitable circuit adapted to provide a battery monitoring output signal (representing an alarm signal) when the battery state of charge and/or state of health falls to the predefined level. Such a circuit for directly measuring state of charge may, for example, be adapted so that a battery voltage below the predefined level biases a transistor to a conductive state so as to apply a suitable signal to input 515. Such a circuit for estimating battery state of health may, for example, monitor charge and discharge cycles for the battery or measure battery physical characteristics to identify the battery monitoring output signal to be applied at input 515. Alternatively to having a separate monitoring circuit such as circuit 509, input 515 may comprise an analog input to controller 501, and the controller may be adapted to react directly to the battery voltage (or a derived voltage) when it reaches a certain predefined minimum level. Thus a battery monitoring circuit may be implemented through controller 501 is some embodiments. Implementations of a zone control device 408 within the scope of the invention are not limited to any particular technique or hardware arrangement for measuring or estimating the battery state of charge or the battery state of health, or both, and providing the desired alarm signal to prompt the desired “low battery” alarm condition transmission from the zone control device. Also, the controller 501 may be configured to control the zone valve according to the zone valve control sequence in response to the “low battery” alarm condition at times other than a time proximate to the start or end of an irrigation session.

The operation of zone control device 408 to provide wireless transmissions of an alarm condition according to the present invention may now be described with reference to the flow chart of FIG. 6. This method shown in FIG. 6 is performed at each zone control device 408 in the irrigation system and is preferably, but not necessarily, performed for each irrigation session for the respective zone. It will be appreciated that the hardware references in the following discussion are references to hardware elements shown in FIGS. 1-5.

The illustrated representative method includes first detecting a designated time proximate to a start time of an irrigation session for the respective irrigation zone as indicated at process block 601. In response to detecting the designated time, the method includes checking for an alarm condition at the zone. In the event an alarm condition is not detected as represented by a negative outcome at decision box 605, the method proceeds to open the zone valve 404 (FIG. 4) for the irrigation session at the designated session start time as indicated at process block 606. However, if an alarm condition is detected the process branches from decision box 605 to control the zone valve 404 according to a zone valve control sequence corresponding to the detected alarm condition as shown at process block 609.

The process performed at either block 606 or 609 ultimately results in the zone valve 404 being placed in the open state so that irrigation water may flow through emitters 110 for the irrigation session. However, in the case of the control provided at process block 609, the zone valve is opened and closed according to the zone valve control sequence which produces a pattern of pressure and flow rate variations in the irrigation water in main distribution conduit 102 which may be sensed elsewhere in the system and particularly at the master/pulser unit 112. Thus the opening and closing sequence of the zone valve at the time proximate to the session start time for that zone creates a transmission to the master/pulser unit 112 or other receiving device which indicates that the alarm condition has been detected at the zone unit. The receiving device may then take appropriate action in response to the transmission as will be described further below in connection with FIG. 7.

Once the irrigation session has started as a result of either process block 606 or 609, the example process shown in FIG. 6 includes monitoring the irrigation session time as indicated at process block 610. The purpose of this monitoring is to identify the session end time at which the zone valve 404 should be placed in the closed state to terminate the irrigation session. If the session end time is detected as represented by an affirmative outcome at decision box 612 the process includes again checking for an alarm condition as indicated at process block 614. If no alarm condition is detected as represented by a negative outcome at decision box 616, the process proceeds to close the zone valve for that session as indicated at process block 618. However, if an alarm condition is detected the process includes controlling the zone valve according to a zone valve control sequence corresponding to the detected alarm condition as indicated at process block 621. The result at either process block 618 or 621 is that the zone valve is placed in the closed state to terminate that irrigation session. The process may then return to an overall irrigation control program as indicated at process block 624 and await the next session start time to be detected as at block 601 for another instance of the process shown in FIG. 6.

It will be appreciated that the example process shown in FIG. 6 checks for an alarm condition both at a designated time proximate to a start time for an irrigation session and also at a designated time proximate to the end time for the irrigation session. Other implementations of the invention may check for an alarm condition only at a designated time proximate to the start of an irrigation session or only proximate to the session end time. In either case the control of the zone valve according to the zone valve control sequence is performed at a time known to the irrigation system (that is, stored in memory included in the system or otherwise available) and thus the master/pulser unit 112 or other receiving unit may be activated at that known time to detect the transmission as will be described below in connection with FIG. 7.

The designated time proximate to the start of an irrigation session indicated at process block 601 may include any suitable time including a proximate time before or after the start of the irrigation session (including any predefined time during the irrigation session), or at a scheduled start time for the session. Where the designated time is selected so that all or part of the zone valve control sequence is performed during a time scheduled for an irrigation session for the given irrigation zone, the run time for the irrigation session may be increased to account for the effect of the zone valve control sequence on irrigation at the zone. That is, when the zone valve 404 is closed in a given zone valve control sequence, the closure interferes with the application of irrigation water through emitters 110. Thus if any part of the zone valve control sequence occurs during a scheduled session run time for the irrigation zone, there is a chance that the zone valve control sequence will interfere with the intended irrigation. Although the times in the zone valve control sequence during which the valve may be closed may represent a very short period of time compared to the run time for an irrigation session, preferred implementations may increase the session run time slightly in order to avoid any interference with the desired irrigation at the irrigation zone. Alternatively, the designated time proximate to the start time for a given zone may be selected so that the zone valve control sequence is completed before or at the scheduled start time for the irrigation session to avoid any interference with the desired irrigation at the zone. Similarly, a designated time proximate to the end of the irrigation session may be selected so that any zone valve control sequence that is performed may be commenced at or immediately after the desired end time for the session so that the sequence is performed over a time period after the session end time to avoid any impact of the zone valve control sequence on the desired irrigation, and terminate with the zone valve in its closed state. However, in cases where the designated time proximate to the start or end time for an irrigation session is outside of the time for the session, the different irrigation sessions for different zones (105 in FIG. 1) must be defined so that the start or end of one irrigation session in the system does not overlap in time with a zone valve control sequence of another irrigation zone. This may be accomplished by simply ensuring that the irrigation schedules for the irrigation system include a suitable delay between the end time of one irrigation session in a given irrigation schedule and the start time of the next irrigation session in that schedule. The suitable delay may be any delay that ensures a given zone valve control sequence is complete outside of the irrigation run time and potential zone valve control sequence for another irrigation zone. For example, where zone valve control sequences are defined to take thirty (30) seconds or less immediately before or after an irrigation session, a delay of more than one (1) minute (and preferably plus a suitable safeguard time period) between the end of one irrigation session and the start of the next irrigation session in an irrigation program would ensure no interference between different zone control sequences or between a zone control sequence for one irrigation zone and the irrigation session for the adjacent irrigation session in an irrigation schedule for the irrigation system.

The process of checking for an alarm condition may be performed in any fashion suitable for the given alarm condition. For example, in the case of the implementation shown in FIG. 5, the alarm condition may be defined as a voltage output from the battery below a predefined value. Continuing with this example, where input 515 is a digital input, battery monitoring circuit 509 may be adapted to apply a signal at one logical state to represent a battery voltage above the predefined voltage level and the opposite logical state to represent a battery voltage below a predefined “low” battery level. Thus checking for the alarm condition may include reading the value supplied by circuit 509 to alarm condition input 515. This read operation is performed under the control of operational program code executed by controller 501 in the example embodiment. The predefined value for a low battery situation may be selected so that the alarm condition is signaled well before the battery power is unable to actuate the zone valve (particularly according to the corresponding zone valve control sequence). Thus the alarm condition transmission arrangement is able to communicate the low battery condition in time to allow the system operator to replace the battery before zone unit 108 becomes inoperable to provide the desired irrigation to the corresponding irrigation zone. It should be appreciated though, that the transmission technique according to the invention is not limited to a low battery condition as the alarm condition, or to any particular alarm condition. Generally, an alarm condition that may trigger a transmission from a zone unit 108 may include any state or condition associated with or related to the operation of the zone unit.

Where the system is designed only to check for a single alarm condition (such as the low battery state described above) the system may have only a single zone valve control sequence to apply at process block 609 and 621. For example, if the system is implemented to send a transmission (that is, the detectable pattern of irrigation water variations) only for a low battery condition, controller 501 may simply be programed by suitable operational program code to apply the predefined signal pattern to valve driver circuit 510 to cause the zone valve to open and close in the predefined sequence. However, where there are multiple different types of alarm conditions defined for the zone unit 108, the process may require a separate step of identifying the particular zone valve control sequence to apply at process block 609 and 621 for the detected alarm condition. The process of identifying the zone valve control sequence for the detected alarm condition may comprise, for example, querying a table that correlates each detectable alarm condition to the predefined sequence. Such a table may be stored in external memory 502 or memory on board controller 501.

The process performed to detect the designated time according to process block 601 may be any suitable process that ultimately allows any transmission needed at process block 609 to be accomplished at the desired time proximate to the given session start time. In some cases the zone unit controller 501 may be adapted to store an irrigation schedule for the zone, and may implement a clock and calendar to maintain the time at the zone unit. Zone unit controller 501 may then be programed to monitor the clock and calendar for the designated time proximate to the start time for an irrigation session. Alternatively, zone unit controller 501 may not store an irrigation schedule for the zone and may instead rely on an instruction from an external device such as master/pulser unit 112 to start and end an irrigation session or start and irrigation session for a particular run time. In these cases where the zone unit controller 501 reacts to a communication from an external source to start an irrigation session, the detection step at process block 601 may comprise detecting receipt of the start irrigation communication or command.

Similarly, the monitoring performed according to process block 610 may be performed by any technique that ultimately allows any transmission needed at process block 621 to be accomplished at the desired time proximate to the given session end time. For example, where zone unit controller 501 is operable to start an irrigation session for a given session run time, the monitoring step at block 610 may include setting a timer for the run time and monitoring for the run time to expire. Alternatively, if zone unit controller 501 is operable to run an irrigation session to a particular time of day and date, then the monitoring at block 610 may include periodically monitoring for that time of day and date to detect the irrigation session end time. As a further alternative, the monitoring at block 610 may be monitoring for receipt of an end session command or instruction from a remote device such as master/pulser unit 112.

The zone valve control sequence employed for a given alarm condition may comprise any sequence of opened and closed states of zone valve 404 that can be detected by monitoring one or more parameters of the fluid in the main distribution conduit 102 in FIG. 1. For example, from a state at which main distribution conduit 102 is supplied irrigation water at a suitable pressure and all of the zone valves 404 are in a closed state, opening the zone valve of a given zone unit 108 rapidly produces a pressure drop in the main distribution conduit 102 which may be detected remotely from that zone, and particularly at master/pulser unit 112. The opened zone valve also rapidly induces a flow through the main distribution conduit 102 which can be detected by a flow sensor at any point upstream of the zone, including at master/pulser unit 112. Closing the zone valve 404 again with the supply to main distribution conduit 102 still open and the other zone valves closed causes the pressure in the main distribution conduit to quickly rise to the supply pressure and rapidly stops the flow of irrigation water in the main distribution conduit. This stoppage of flow will register at a flow sensor such as flow sensor 207 at master/pulser unit 112 and the pressure increase will be detected at pressure sensor 206 (in FIG. 2). The period that zone valve 404 may be opened or closed in the zone valve control sequence may be any time necessary to provide a discernable pressure and/or flow transition in the main distribution conduit. For example, each open state for zone valve 404 in a given zone valve control sequence may be maintained for one second and each closed state for the valve may also be maintained for one second. However, the open and closed times in a given sequence need not be equal. Any sequence which can be discerned via the pressure and/or flow reaction at the remote receiving device such as master/pulser unit 112 may be used within the scope of the present invention. An example sequence proximate to a start of an irrigation session might be the sequence, open for one second, closed for one second, open for one second, and closed for one second, after which the zone valve is opened for the irrigation session. An example sequence proximate to an end of an irrigation session might be the sequence, closed for two seconds, open for two seconds, closed for two seconds, and open for two seconds, and then the zone valve is closed to end the irrigation session. It will be appreciated that the time required for a discernable pressure and/or flow rate increase or decrease will be somewhat dependent upon the size of the irrigation system and the supply pressure applied (at supply 114 in the example of FIG. 1), and also dependent upon the sensitivity of the sensor or sensors used to measure the pressure and/or flow rate, or other suitable parameter. Thus the open and closed times for a zone valve control sequence within the scope of the present invention should be selected with these factors in mind and in any event to produce the desired detectable pattern.

A zone valve control sequence may be defined so as to produce a pattern of pressure and flow states in the main distribution conduit representing a binary logic signal. In such an arrangement a pressure at or above a predefined value expected when the zone valves are all in the closed state may represent a one logical value and a pressure at or below a predefined value expected when one zone valve is in an open state may represent the opposite logical value. Similarly, a flow rate at or below a predefined value expected when the zone valves are all in the closed state may represent one logical value and a flow rate at or above a predefined value expected when one zone valve is in an open state may represent the opposite logical value. Defining a zone valve control sequence to produce a pressure and flow rate pattern that may be processed as a binary logic signal at the receiving device (such as master/pulser 112 in the example system) allows the use of common digital processing techniques to detect the pattern, however, the invention is not limited to any particular processing technique to detect the pattern produced by a given zone valve control sequence.

It should be noted that an alarm condition that is checked as shown at block 602 and 614 in FIG. 6 might be indicated at any time and not just at the time at which the check is performed. For example, a low battery condition which may be detected by circuit 509 in FIG. 5 (or otherwise) may occur at any time and may simply set a bit in memory at controller 501 or elsewhere at the time of the detection. The check performed at either 602 or 614 in FIG. 6 may comprise reading that bit.

FIG. 7 shows a process performed at the master/pulser unit 112 to receive a transmission from a zone unit 108 in the example system shown in FIG. 1. As shown in FIG. 7 the process includes monitoring one or more parameters (such as pressure and/or flow rate) of the fluid in the main distribution conduit 102 as indicated at process block 701. This monitoring is performed at least at, and preferably in a time window around the designated time proximate to the start and/or end time for an irrigation session at a respective irrigation zone in the system. The monitoring is performed to detect changes in the monitored parameter or parameters, and particularly a pattern of changes, corresponding to those expected to be caused by opening and closing the zone valve in accordance with a zone valve control sequence that may be used in the system, and thus represent a transmission of an alarm condition from the given irrigation zone. In the event the appropriate continuous flow state is detected at the designated time for the start or end of the session as represented by an affirmative outcome at decision box 704, the process returns to the overall irrigation system control process. This return step can be taken because the continuous flow state over the time of the inquiry (a continuous flow at the designated time proximate to the session start time and continuous no-flow state at the designated time proximate to the session end time) indicates no zone valve control sequence is being performed and thus no alarm condition is indicated. In the event a discontinuous flow state is detected in accordance with the monitoring at process block 701, and the time for an expected pattern is exceeded as represented by an affirmative outcome at decision box 706, the process branches to send an error message as shown at process block 708. This error message sent at 708 is indicated because the zone valve at the zone unit in question appears to be opening and closing to produce an intermediate flow pattern, but not a flow pattern that is recognizable as corresponding to an alarm condition. However, if an expected flow pattern is detected within the time window proximate to the session start/end time in which the pattern is expected (as represented by an affirmative outcome a decision box 710), then the process sends an alarm message dictated by the detected pattern as indicated at process block 714. The main system control process is then resumed as indicated at process block 716.

In order to receive and recognize a transmission from a respective zone unit 108, the receiving device, in this example the master-pulser unit 112, relies on knowledge of the predefined start time for an irrigation session at the respective irrigation zone 108 and/or the session end time. This information at the receiving device may be obtained in several different ways. In some implementations it is a transmission from master/pulser unit 112 to a given zone unit 108 that directs the zone unit to start an irrigation session. In these cases, master/pulser unit 112 knows when it sends such a signal and thus knows when to monitor (in accordance with process block 701) for a possible transmission back from the zone. For example, master/pulser unit 112 may be operable to monitor for a potential transmission for a suitable time beginning immediately after a start command is transmitted to a zone unit 108. That suitable monitoring time may be any time within the irrigation session run time that a transmission may be sent from the zone unit 108. Similarly, where master/pulser unit 112 sends an end session command or time, it may monitor the flow parameter(s) in accordance with process block 701 within a suitable window of time at the end of the irrigation session.

Even when a zone unit 108 operates according to an irrigation schedule stored at the zone unit, master/pulser unit 112 may store the same schedule. Thus master/pulser unit 112 may monitor the flow parameter(s) in accordance with process block 701 in a suitable window of time encompassing the times proximate to the irrigation session start and end times for the given zone unit in which period of time an alarm condition transmission might be sent from the zone unit. It should be noted that the master/pulser unit 112 may be responsible for communicating a respective irrigation schedule to each zone unit 108, and may thus store each such schedule at the time it is communicated to the zone unit.

Regardless of how the master/pulser unit 112 has the information to perform the monitoring indicated at process block 701 in FIG. 7, the process shown in that figure may be performed as part of a system control process that controls irrigation in the system through the various zone units 108 shown in FIG. 1. The process shown in FIG. 7 may represent a subroutine invoked at a predefined time selected to encompass the designated time proximate to a start/end time for a respective irrigation session at a given irrigation zone. Thus the return to the system control process indicated at process block 716 may comprise simply returning to the irrigation control program being executed at controller 301.

A transmission from a zone unit according to the present invention is received at the receiving device, master/pulser unit 112 in this case, by the sensor device or devices which may monitor the parameter(s) in main distribution conduit 102. In the example master/pulser unit 112 shown in FIG. 2, pressure sensor 206 may detect variations in the pressure in main distribution conduit 102 representing a pattern produced by the performance of the zone valve control sequence at 609 or 621 in FIG. 6. Also, flow sensor 207 in FIG. 2 may detect variations in the flow rate in main distribution conduit 102 representing a pattern produced by the performance of the zone valve control sequence at 609 or 621 in FIG. 6. In either case, the parameter (pressure or flow rate) variations are communicated to master/pulser unit controller 301 (in this example) for processing to determine if the variations match an expected pattern corresponding to a zone valve control sequence for an alarm condition. For example, a digital representation of the variations in pressure or flow rate, or some combination of pressure and flow rate may be produced by controller 301 and compared to a digital representation of variations corresponding to those expected to be produced by a given zone valve control sequence.

The messages sent at either process block 708 or 716 in FIG. 7 may comprise any suitable message and may be sent in any fashion. For example, where it is a low battery condition that prompted the alarm input and subsequent zone valve control sequence and consequent parameter variations detected by the monitoring at process block 701 in FIG. 7, the message sent at process block 714 may include a message indicating the low battery condition and providing an identifier for the respective zone unit 108 in which the condition is detected. Process block 708 is reached when an intermittent flow is detected at the designated time, but the intermittent flow does not produce a recognizable pattern of the monitored parameter(s). The message in this case may indicate a malfunction and include an identifier for the zone unit 108 in which the condition is detected. In either case, the example hardware arrangement shown in FIG. 3 may send the message via serial port 310 to be displayed at a physical control/alarm panel for the irrigation system or a virtual control/alarm panel which might be displayed on a computer monitor or mobile device.

As used herein, whether in the above description or the following claims, the terms “comprising,” “including,” “carrying,” “having,” “containing,” “involving,” and the like are to be understood to be open-ended, that is, to mean including but not limited to. Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The term “each” may be used in the following claims for convenience in describing characteristics or features of multiple elements, and any such use of the term “each” is in the inclusive sense unless specifically stated otherwise. For example, if a claim defines two or more elements as “each” having a characteristic or feature, the use of the term “each” is not intended to exclude from the claim scope a situation having a third one of the elements which does not have the defined characteristic or feature.

The above described preferred embodiments are intended to illustrate the principles of the invention, but not to limit the scope of the invention. Various other embodiments and modifications to these preferred embodiments may be made by those skilled in the art without departing from the scope of the present invention.

1. A method of wirelessly transmitting alarm condition information from an irrigation zone of an irrigation system, the method including:
(a) detecting an alarm condition at the irrigation zone, the irrigation zone including a zone input conduit connected to a main distribution conduit of the irrigation system, a zone distribution conduit, a zone valve connected between the zone input conduit and the zone distribution conduit, and at least one irrigation emitter connected in the zone distribution conduit, the zone valve being operable to reside alternately in an open state enabling fluid flow from the zone input conduit to the zone distribution conduit and a closed state blocking fluid flow from the zone input to the zone distribution conduit; and
(b) at a designated time proximate to one of a start time and an end time for an irrigation session for the irrigation zone, controlling the zone valve according to a zone valve control sequence corresponding to the detected alarm condition, the zone valve control sequence comprising a predefined pattern of states of the zone valve over time.

2. The method of claim 1 wherein the designated time is determined relative to a start time for the irrigation session and the zone valve control sequence ends with the zone valve in the open state.

3. The method of claim 1 wherein the designated time is determined relative to an end time for the irrigation session and the zone valve control sequence ends with the zone valve in the closed state.

4. The method of claim 1 wherein detecting the alarm condition includes reading a battery status signal for a battery of the irrigation zone.

5. The method of claim 1 wherein detecting the alarm condition is performed at a detection time defined relative to the irrigation session.

6. The method of claim 1 further including, in response to the designated time, sensing a zone state-indicating parameter of the main distribution conduit at a location remote from the irrigation zone.

7. The method of claim 6 further including, in response to detecting a pattern of the zone state-indicating parameter of the main distribution conduit corresponding to the zone valve control sequence, performing an action corresponding to the zone valve control sequence.

8. A zone control device for a zone in an irrigation system, the zone control device including:
(a) zone valve output terminal;
(b) a zone valve signal circuit operable to apply a zone valve drive signal to the zone valve output terminal in response to a zone valve control signal;
(c) a zone unit controller having an alarm condition input, the zone unit controller operable to, in response to an alarm condition signal received at the alarm condition input, direct the zone valve control signal to the zone valve signal circuit according to a zone valve control sequence at a designated time proximate to one of a start time and an end time for an irrigation session for the irrigation zone, the zone valve control sequence comprising a predefined pattern of states of the zone valve over time; and
(d) a battery connected to supply operating power at least to the zone unit controller.

9. The zone control device of claim 8 wherein the signal received at the alarm condition input comprises a signal indicative of a state of charge or state of health of the battery.

10. The zone control device of claim 9 wherein the alarm condition input comprises a digital input to the zone unit controller and further including a battery monitoring circuit connected to the battery and having a battery monitoring output connected to the alarm condition input.

11. The zone control device of claim 8 wherein the zone valve control signal is directed to the zone valve signal circuit according to the zone valve control sequence at the start time of the irrigation session for the zone in the irrigation system and the zone valve control sequence ends with the zone valve in the open state.

12. The zone control device of claim 8 wherein the zone valve control signal is directed to the zone valve signal circuit according to the zone valve control sequence at the end time of the irrigation session for the zone in the irrigation system and the zone valve control sequence ends with the zone valve in the closed state.

13. The zone control device of claim 8 wherein the zone unit controller is operable to direct the zone valve control signal to the zone valve signal circuit according to the zone valve control sequence in response to the alarm condition signal received at the alarm condition input at multiple points in time defined relative to the irrigation session for the zone in the irrigation system.

14. An irrigation system including:
(a) a main distribution conduit;
(b) a number of irrigation zones, each irrigation zone including an input conduit connected to the main distribution conduit, a zone valve, a zone distribution conduit, and one or more irrigation emitters connected to the zone distribution conduit, the zone valve being connected between the zone input conduit and the zone distribution conduit and being operable to reside alternately in an open state enabling fluid flow from the zone input conduit to the zone distribution conduit and a closed state blocking fluid flow from the zone input to the zone distribution conduit; and
(c) a first irrigation zone of the number of irrigation zones including a zone control device, the zone control device including:
(i) a zone valve output terminal connected to an input of the zone valve;
(ii) a zone valve signal circuit operable to apply a zone valve drive signal to the zone valve output terminal in response to a zone valve control signal;
(iii) a zone unit controller having an alarm condition input, the zone unit controller operable to, in response to an alarm condition signal received at the alarm condition input, direct the zone valve control signal to the zone valve signal circuit according to a zone valve control sequence at a designated time proximate to one of a start time and an end time for an irrigation session for the irrigation zone, the zone valve control sequence comprising a predefined pattern of states of the zone valve over time; and
(iv) a battery connected to supply operating power at least to the zone unit controller.

15. The irrigation system of claim 14 wherein the signal received at the alarm condition input comprises a signal indicative of a state of charge or a state of health of the battery.

16. The irrigation system of claim 15 wherein the alarm condition input comprises a digital input to the zone unit controller and further including a battery monitoring circuit connected to the battery and having a battery monitoring output connected to the alarm condition input.

17. The irrigation system of claim 14 wherein the zone valve control signal is directed to the zone valve signal circuit according to the zone valve control sequence at the start time of the irrigation session for the zone in the irrigation system and the zone valve control sequence ends with the zone valve in the open state.

18. The irrigation system of claim 14 wherein the zone valve control signal is directed to the zone valve signal circuit according to the zone valve control sequence at the end of the irrigation session for the zone in the irrigation system and the zone valve control sequence ends with the zone valve in the closed state.

19. The irrigation system of claim 14 wherein the zone unit controller is operable to direct the zone valve control signal to the zone valve signal circuit according to the zone valve control sequence in response to on a signal received at the alarm condition input at multiple points in time defined relative to the irrigation session for the zone in the irrigation system.

20. A zone control device for a zone in an irrigation system, the zone control device including:
(a) zone valve output terminal;
(b) a zone valve signal circuit operable to apply a zone valve drive signal to the zone valve output terminal in response to a zone valve control signal;
(c) a battery connected to supply operating power to the zone control device; and
(d) a zone unit controller having an alarm condition input, the zone unit controller operable to, in response to an alarm condition signal received at the alarm condition input, direct the zone valve control signal to the zone valve signal circuit according to a zone valve control sequence, the zone valve control sequence comprising a predefined pattern of open and closed states of the zone valve over time, and the alarm condition signal comprising a signal indicative of a state of charge or state of health of the battery.
